(19) United States
(12) Patent Application Publication
(10) Pub. No.: US 2014/0122144 A1
(43) Pub. Date: May 1, 2014

(54) Initiative and Project Management

(71) Applicants: Vytas Cirpus, Waldsee (DE); Sandra Schmidt, Bruchsal (DE); Beate Riefer, Walldorf (DE); Heinrich Lammering, Stuttgart (DE); Matthias Woerner, Dielheim (DE); Dieter Krisch, Karlsruhe (DE); Hans Christian Gaedke, Dielheim (DE); Ralph Rillig, Mutterstadt (DE); Joerg Goeppert, Karlsruhe (DE); Andre Sondermann, Ople (DE); Sabine Lamprecht, Nussloch (DE); Dirk Rohdemann, Muehlhausen (DE); Katharina Sorge, Rauenberg (DE); Volker Schott, Nussloch (DE)

(72) Inventors: Vytas Cirpus, Waldsee (DE); Sandra Schmidt, Bruchsal (DE); Beate Riefer, Walldorf (DE); Heinrich Lammering, Stuttgart (DE); Matthias Woerner, Dielheim (DE); Dieter Krisch, Karlsruhe (DE); Hans Christian Gaedke, Dielheim (DE); Ralph Rillig, Mutterstadt (DE); Joerg Goeppert, Karlsruhe (DE); Andre Sondermann, Ople (DE); Sabine Lamprecht, Nussloch (DE); Dirk Rohdemann, Muehlhausen (DE); Katharina Sorge, Rauenberg (DE); Volker Schott, Nussloch (DE)

(21) Appl. No.: 13/666,533

(22) Filed: Nov. 1, 2012

(51) Int. Cl. G06Q 10/06

(52) U.S. Cl. 705/7.14

(57) ABSTRACT

An initiative object corresponding to an organization decision to explore a topic is defined, and a first goal definition and a first skills definition for the initiative object are defined. A project object corresponding to a project undertaken by the organization is defined, the project associated with exploring the topic, and a second goal definition and a second skills definition for the project object are defined. Employees are searched in an employee skills database using at least one of the first or second skills definitions, and assigned to the initiative object and to the project object, wherein the project object, but not the initiative object, affects employee availability. Upon closing the initiative object or project object, a skills record is updated using the first or second skills definitions; and upon closing the initiative object or project object, a performance record is updated using the first or second goal definitions.

### BACKGROUND

Organizations, such as corporations or other companies, sometimes organize their business efforts into one or more projects. For each project, the necessary resources (e.g., employees and/or equipment) must be scheduled, and the project must also be monitored and perhaps adjusted in one or more ways. After the project is concluded, feedback is sometimes collected regarding the project execution and/or the performance of individual employees. Such information can then be shared with one or more people, for example in an annual employee review session.

### SUMMARY

In a first aspect, a computer-implemented method includes: defining, in a computer system operated by an organization, an initiative object corresponding to an organization decision to explore a topic, and specifying at least a first goal definition and at least a first skills definition for the initiative object; defining, in the computer system, a project object corresponding to a project undertaken by the organization, the project associated with exploring the topic, and specifying at least a second goal definition and at least a second skills definition for the project object; searching for one or more employees in an employee skills database of the organization, the searching performed using at least one of the first or second skills definitions, and assigning at least one employee to the initiative object and to the project object, wherein the project object, but not the initiative object, affects employee availability; upon at least one of the initiative object and the project object being closed, updating a skills record for the employee using at least one of the first and second skills definitions; and upon at least one of the initiative object and the project object being closed, updating a performance record for the employee using at least one of the first and second goal definitions.

In a second aspect, a computer program product is embodied in a non-transitory computer-readable storage medium and includes instructions that when executed by a processor perform a method. The method includes: defining, in a computer system operated by an organization, an initiative object corresponding to an organization decision to explore a topic, and specifying at least a first goal definition and at least a first skills definition for the initiative object; defining, in the computer system, a project object corresponding to a project undertaken by the organization, the project associated with exploring the topic, and specifying at least a second goal definition and at least a second skills definition for the project object; searching for one or more employees in an employee skills database of the organization, the searching performed using at least one of the first or second skills definitions, and assigning at least one employee to the initiative object and to the project object, wherein the project object, but not the initiative object, affects employee availability; upon at least one of the initiative object and the project object being closed, updating a skills record for the employee using at least one of the first and second skills definitions; and upon at least one of the initiative object and the project object being closed, updating a performance record for the employee using at least one of the first and second goal definitions.

In a third aspect, a system includes: one or more processors; and a computer program product embodied in a non-transitory computer-readable storage medium and comprising instructions that when executed perform a method. The method includes: defining, in a computer system operated by an organization, an initiative object corresponding to an organization decision to explore a topic, and specifying at least a first goal definition and at least a first skills definition for the initiative object; defining, in the computer system, a project object corresponding to a project undertaken by the organization, the project associated with exploring the topic, and specifying at least a second goal definition and at least a second skills definition for the project object; searching for one or more employees in an employee skills database of the organization, the searching performed using at least one of the first or second skills definitions, and assigning at least one employee to the initiative object and to the project object, wherein the project object, but not the initiative object, affects employee availability; upon at least one of the initiative object and the project object being closed, updating a skills record for the employee using at least one of the first and second skills definitions; and upon at least one of the initiative object and the project object being closed, updating a performance record for the employee using at least one of the first and second goal definitions.

Implementations can include any or all of the following features. An initial search of the employee skills database finds no match for at least one of the first or second skills definitions, and the method further includes updating a resource management record to reflect the at least one of the first or second skills definitions. The assignment of the at least one employee to the initiative object and to the project object results from one or more of employee hiring, employee training, or consultant retention. The method further includes associating a third goal definition with the at least one employee using the updated performance record. The method further includes providing, using the computer system, an interface for collaboration between at least two users involved in at least one of the exploration of the topic or the project. The project object is defined using the initiative object. The project object already exists, and the method further includes associating the initiative object with the existing project object.

Implementations can provide any or all of the following advantages. One or more of the following can be made more flexible and efficient: management of initiatives or projects, updating of employee skills records, definition of individual employee development goals, or strategic management of resources.

The details of one or more implementations are set forth in the accompanying drawings and the description below. Other features and advantages will be apparent from the description and drawings, and from the claims.

### DESCRIPTION OF DRAWINGS

FIG. 1 schematically shows an example of a system that can manage initiatives and projects with regard to goals and employee skills.

FIG. 2 schematically shows an example of a system that can define and use an initiative object and a project object.

FIG. 3 shows an example of a graphical user interface (GUI) for managing an initiative.

FIG. 4 shows an example of a GUI for defining a new initiative.

FIG. 5 shows another example of a GUI for managing an initiative.

FIG. 6 shows another example of a GUI for defining a new initiative.

FIG. 7 shows an example of a GUI for defining one or more milestones regarding an initiative.

FIG. 8 shows an example of a GUI for managing one or more projects relating to an initiative.

FIG. 9 is a block diagram of a computing system that can be used in connection with computer-implemented methods described in this document.

Like reference symbols in the various drawings indicate like elements.

### DETAILED DESCRIPTION

This document describes systems and techniques that can manage company initiatives and projects based on employee skills, and can facilitate updating of relevant employee records based on a finished initiative or project. For example, a user can define an initiative and assign one or more skills as required for that initiative, and/or that are required for any subordinated project(s). Such skill definitions can be used for one or more purposes. As a first example, the task of finding the right person can be aided by a skill-dependent staffing of the initiative or the subordinated project. Depending on the skill(s) defined in the initiative/project, the responsible user (e.g., a project lead and a people manager) can select the employee(s) with the required skills from an employee pool. This assumes that a skills database has been created where skills are assigned to various employees. The project lead can also or instead use the skills definition to plan further education actions for employees.

As a second example, integration to a performance and reward system can aid in recognizing that one or more individual employee goals have been satisfied by participation in the initiative/project. For example, the people manager or the employee can derive appropriate goals from the assignment of the employee(s) to the initiative/project. The project lead can serve as an (additional) performance evaluator and can give feedback on project members, which feedback is collected and consolidated (e.g., by the people manager) to prepare a final assessment of the employee(s).

As a third example, the skill definition associated with the initiative/project can be used to update a skills record for the participating employee (e.g., in the skills database.) This can be done by the employee and/or by the people manager. Moreover, company management can evaluate the achievement of project goals and use them in the performance feedback process for involved employees. As another example, the project lead can document “lessons learned” in the system so that they can benefit future initiatives/projects.

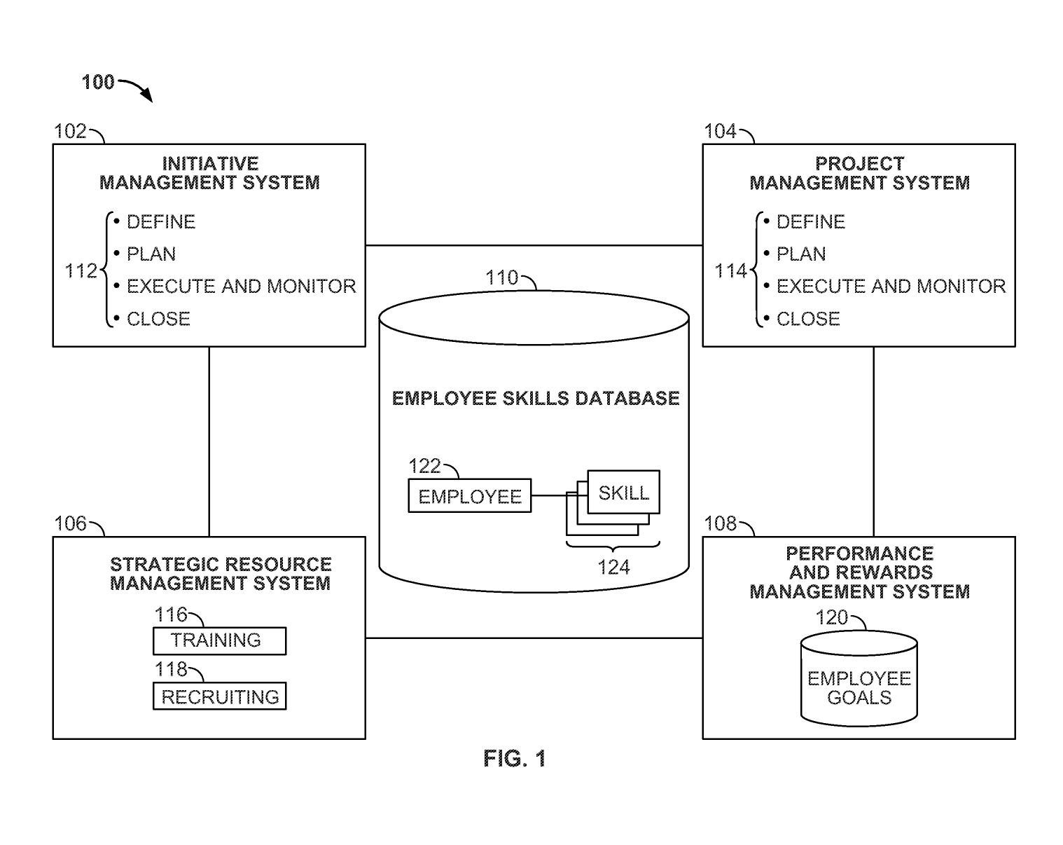

FIG. 1 schematically shows an example of a system 100 that can manage initiatives and projects with regard to goals and employee skills. The system 100 includes an initiative management system 102, a project management system 104, a strategic resource management system 106, a performance and rewards management system 108, each of which can communicate with one or more of the other systems and/or with an employee skills database 110. In some implementations, one or more additional or fewer components can be used. Also, two or more of the shown components can be implemented on a common physical device (e.g., a server), and any of the components can be distributed over more than one physical device.

Regarding the initiative management system 102, an initiative can be used as a lightweight, informal project without direct association with company financial processes. For example, an initiative can be characterized as “build prototype as proof of concept to win a customer.”

Also, or instead, an initiative can be used as a bracket across projects to realize undertakings that are larger than a typical single project. In some implementations, the initiative serves as an umbrella for the overall undertaking and is used for tracking strategic goals, whereas the actual execution is done in the context of the projects of the initiative. For example, an initiative can be called “company conquers the cloud business” and can be organized into projects named “acquire cloud know-how,” “ramp up development” and “deliver first version,” respectively. As another example, an initiative can be called “reducing operational costs of hosting” and its projects can be named “evaluate main costs drivers,” “find alternative approaches,” “transition to new approach without disruption—pilot” and “transition to new approach without disruption—all customer base.”

The initiative management system 102 can manage initiatives using one or more initiative objects and one or more actions 112 associated with the object(s). For example, one or more users can operate the system 102 to define a new initiative object, plan how the initiative should be performed using the initiative object, execute the initiative and monitor the performance thereof, and finally closing the initiative object when the initiative ends.

In some implementations, the system 104 provides project creation as well as handles the cost side thereof. For example, the system 104 can include a Financials onDemand system available from SAP AG; an SAP Enterprise Resource Management (ERP) Financial system (FIN) and a Project system (PS) available from SAP AG; and/or a third-party system.

The project management system 104 can manage projects using one or more project objects and one or more actions 114 associated with the object(s). For example, the project object(s) can be defined, planned, executed, monitored and closed in analogy with the initiative object mentioned above. In some implementations, projects can be used without initiatives, or vice versa.

The strategic resource management system 106 can be used for resources including, but not limited to, employees, information technology (IT), equipment, facilities, vehicles and/or buildings, to name just a few examples. In some implementations, the system 106 is notified when an employee skill is being sought. Also, when an employee is assigned to a project, the system 106 can adjust the employee's availability accordingly (e.g., to indicate that the employee is partially or entirely unavailable for the specified time period.)

For example, if the system 106 detects that employees with “cloud know-how” are being sought but typically are not found within the organization, the system 106 can initiate one or more actions, such as alerting a training component 116 that manages scheduling and execution of employee training (e.g., to develop cloud know-how), and/or a recruiting component 118 that manages recruiting efforts for the organization (e.g., to hire cloud experts), and/or one or more external consultants (e.g., cloud experts) can be retained.

The performance and rewards management system 108 manages the performance evaluations for all employees and can also handle rewards given to the employees (e.g., a bonus at the end of the year.) The system 108 can also maintain an employee goals repository where each employee can have assigned to him or her one or more individual goals to be accomplished. For example, such goals can be set by the person manager and/or by the employee.

The employee skills database 110 includes at least one employee object 122 for each employee whose skills are being tracked. The employee object can include relevant information about the employee, such as an employee ID and/or demographic information. The employee object 122 can be associated with one or more skills objects 124. For example, the skills object 124 can indicate “cloud know-how” and the assignment of this skills object to the employee object indicates that the organization recognizes the employee as having (acquired) this skill. In some implementations, the skills object can include one or more portions of information pertaining to the employee. For example, a grade or score or other value can be included to indicate a measure of the extent to which the employee possesses this skill (e.g., “has a significant amount of.”) As another example, historical information (e.g., initiative/project participation) can be included to indicate at least one factor contributing to this skill in the employee.

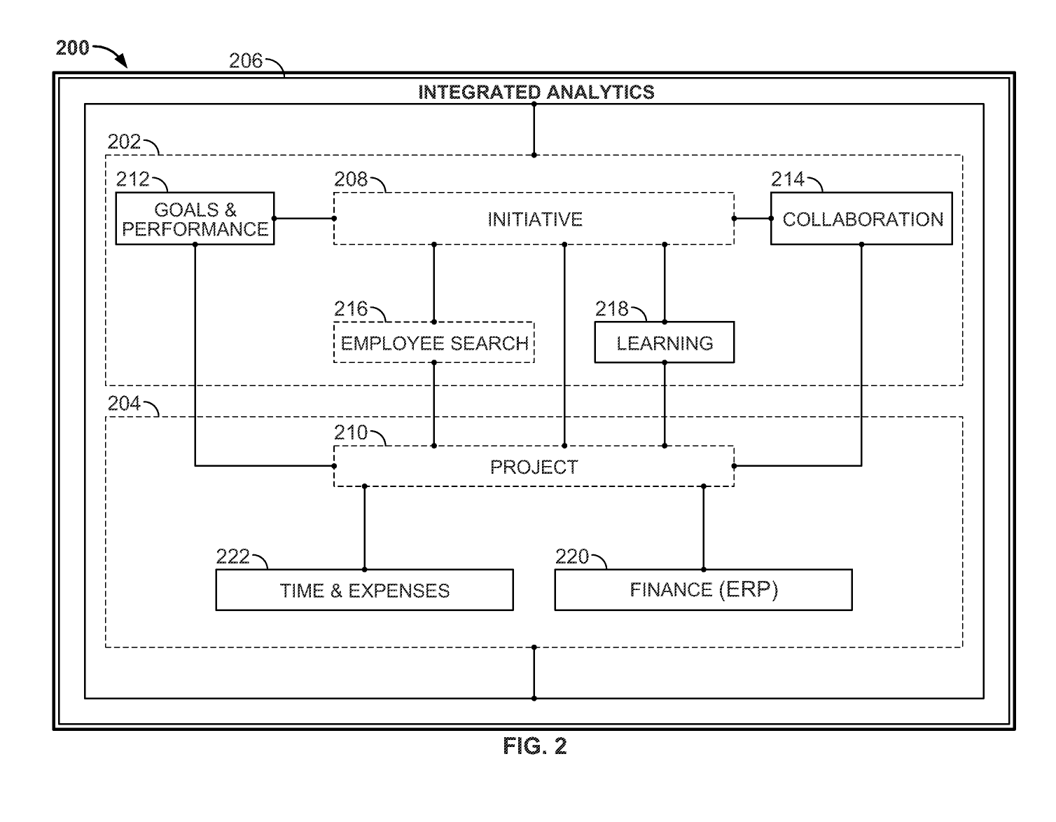

FIG. 2 schematically shows an example of a system 200 that can define and use an initiative object and a project object. The system 200 here includes a first system 202 and a second system 204 implemented generally within an integrated analytics framework 206. In some implementations, the first system 202 includes one or more BizX solutions available from SuccessFactors, Inc. For example, the Employee Central (EC) solution can be included. In some implementations, the second system 204 includes one or more project related systems. For example, a FIN or ERP or PS systems available from SAP AG can be included.

The system 200 has defined therein one or more initiative objects 208 and one or more project objects 210. Both objects are integrated into the system 200 to serve one or more purposes. For example, integration into a goals and performance management component 212 (e.g., the performance and rewards management system 108 in FIG. 1) can allow use of the object 208 and/or 210 in deriving individual goals from projects or initiatives. As another example, integration into a collaboration component 214 (e.g., the Jam solution available from SuccessFactors, Inc.) can provide increased productivity via social collaboration. The collaboration component 214 can provide an interface for collaboration between at least two users involved in exploration of a topic and/or project. As another example, integration into an employee search component 216 can facilitate aid in assigning the right people according to skills and competencies, and/or can provide improved utilization of employees according to availability. As another example, integration into a learning component 218 (e.g., the Learning solution available from SuccessFactors, Inc.) can provide efficient management of learning resources. Finally, integration into the integrated analytics framework 206 can provide tracking of progress including, but not limited to, costs.

Accordingly, in some implementations, one or more of the following features of the first system 202 can be applied to the initiative object(s) 208 and to the project object(s) 210: definition and evaluation of goals, definition of tags, specification of one or more required competencies to achieve the goal(s), searching for, and assignment of, employees, and/or collaboration.

Generally speaking, the initiative object 208 reflects an existing initiative. In some implementations, an initiative is a company decision (e.g., a management decision) to explore a topic. An initiative can have any size, such as from small (individual) initiatives to strategic C-level initiatives that have mid- to long-term implications for the company. For example, defining an initiative can lead to initiation of projects aimed at accomplishing the goals.

In some implementations, the initiative object 208 provides some or all of the following functions: defining one or more projects from the initiative, assigning one or more existing projects to the initiative, inviting employees to collaborate in the initiative, managing the initiative without direct involvement of a financial application 218 or sales or other applications (e.g., a time and expenses application 222), and defining one or more goals for the initiative and evaluate the goal upon closing the initiative object, including to update the goals and/or skills of the involved employee(s) based on an outcome.

In some implementations, the project object can belong to any of the following categories: billable projects (e.g., customer projects), internal projects, investment projects, cost collecting projects (e.g., internal orders), and event management projects.

The lifecycle of a project may have common parts, such as those involving the start of projects, execution and monitoring, and project closing. For example, a billable customer project can include the following sequence of steps performed after a “marketing opportunity” event and before a “financial closing” event:
Creating sales quotes
Creating sales orders
Planning projects
Executing projects
Creating project invoice requests
Creating customer invoices
Processing receivables and payment
Closing projects

On the other hand, an internal project may have fewer steps, but they may be similar or identical to those of other projects:
Planning project
Executing project
Closing project

One or more steps can include sub-steps accessible by a drill-down operation. For example, the above “Planning project” can include the following sub-steps:
Create project
Plan project
Create baseline
Release project

That is, in the system 200 there can be defined the project object 210 corresponding to a project undertaken by the organization, the project associated with exploring a topic, and at least one goal definition and at least one skills definition can be specified for the project object 210.

For an initiative, in contrast, the following steps can be used:
Initiate initiative
Execute initiative
Close initiative

The “Execute initiative” steps above can be indirectly executed via one or more assigned projects. That is, in the system 200 there can be defined the initiative object 208 corresponding to an organization decision to explore the topic, and at least one goal definition and at least one skills definition can be specified for the initiative object 208.

The employee search component 216 can be used to search for one or more employees of the organization (e.g., in the employee skills database 110 in FIG. 1). This searching can be performed using skills definition of the initiative object 208 or the project object 210, or both. At least one employee can then be assigned to the initiative object and to the project object.

The actual assignment of the employee to the project for a specific time and a particular effort can be done in the first system 202 or in the second system 204. In some implementations, the second system 204, which handles the project object 210, is the logical owner of the data reflecting the assignment. For example, the assignment of concrete tasks or work packages to team members can logically be located in the second system 204 (e.g., in the project management system 104 in FIG. 1.) Importantly, employee assignment to the project object 210 affects the employee's availability (e.g., which can be managed by the strategic resource management system 106 in FIG. 1). The initiative object, in contrast, does not affect employee availability.

When an initiative or project is finished, additional documentation can be recorded. In some implementations, upon at least one of the initiative object 208 and the project object 210 being closed, a skills record for the employee is updated using at least one of the relevant skills definitions. For example, a people manager or the employee can update the employee skills database 110 (FIG. 1) based on the concluded project.

In some implementations, upon at least one of the initiative object 208 and the project object 210 being closed, a performance record for the employee can be updated using at least one of the relevant. For example, a project manager can update the employee goals repository 120 (FIG. 1) with an evaluation of the employee's performance on the concluded project.

A more detailed example of an initiative and an associated project will now be described. This example involves the following personas:

| Name | Position | Description |
|---|---|---|
| Bill McCloud | (Senior) Manager | Sponsor of and responsible |
| | | for initiatives |
| Wilhelm Schmitz | People (HR) Manager | Line manager of project |
| | | members (e.g. Tom) |
| Lara Bloom | Project Manager | Responsible for planning |
| | | and execution of projects |
| Tom Tailor | Employee | Works in projects as team |
| | | member |

The initiative and the project are defined or otherwise created in a “Define” step:

Persona

| | | | |
|---|---|---|---|
| Bill McCloud | Create | Get approval for | Execute initiative |
| (Senior) Manager | initiative^{a} | initiative^{a} | with project^{a} |
| Lara Bloom | Create project^{b} | | |
| Project Manager | | | |

^{a}= e.g., using the first system 202
^{b}= e.g., using the second system 204

Initiatives can be created in the first system 202 and contain attributes such as purposes/goals, attachments, time frame (including milestones), involved people, priority and status. An approval process for the initiative can be used as an optional step to obtain commitment from all stakeholders. If the execution of an initiative is handled using projects (e.g., in the project management system 104 in FIG. 1), then the project(s) can be created either out of the initiative in the first system 202 (e.g., from the initiative object 208), or an existing project can be linked to the initiative (e.g., the objects 210 and 208 can be associated with each other.)

The initiative and the project can be planned in a “Plan” step:

Name

| | | | | | | | |
|---|---|---|---|---|---|---|---|
| Bill | | Define | Manage | Search | | Assign | |
| McCloud | | skills/roles | skills for | employees^{a} | | employees | |
| (Senior) | | for | initiative^{a} | | | to | |
| Manager | | initiative^{a} | | | | initiative^{a} | |
| Lara | Define | Define | | Search | Request | Assign | Assign |
| Bloom | tasks | required | | employees^{a} | employee | employees | tasks to |
| Project | and | skills/roles | | | staffing^{a} | to project^{c} | team |
| Manager | mile- | for | | | | | members^{b} |
| | stones^{b} | project^{a} | | | | | |
| Wilhelm | | | Manage | | Approve | Assign | |
| Schmitz | | | skills for | | employee | employees | |
| People | | | projects^{a} | | staffing^{a} | to project^{c} | |
| Manager | | | | | | | |

^{a}e.g., using the first system 202
^{b}e.g., using the second system 204
^{c}e.g., using either the first system 202 or the second system 204

The Plan step covers the detailed structuring and staffing of incentives and projects to decide “who does what and when.” The detailed planning (e.g., definition of milestones and tasks) is exclusively done in the second system 204. In some implementations, staffing-related activities (such as setting up a team) are natively integrated into the first system 202 for both projects and initiatives. For example, this can include, definition of required skills, search for employees using skills and availability, staffing requests with approval process, and if necessary the organization of learning modules for additional training or education (e.g., “upskilling.”) The actual assignment of employees to a project for a given time frame and a committed effort can be done in the first or second system. As noted earlier, the project object 210 affects employee availability but the initiative object 208 does not.

The initiative and the project can be performed in an “Execute and monitor” step:

Name

| | | | | | | | |
|---|---|---|---|---|---|---|---|
| Bill | Onboarding | | | Track | Receive | Adapt | Stop |
| McCloud | and | | | initiative | project | initiative | initiative^{a} |
| (Senior) | collaboration^{d} | | | progress^{e} | status | staffing^{a} | |
| Manager | | | | | update^{d} | | |
| Lara | Onboarding | | Approve | Track | Provide | Adapt | Stop |
| Bloom | and | | confirmations | project | status to | project | project^{b} |
| (Project | collaboration^{d} | | and | progress^{e} | stakeholders | staffing^{c} | |
| Manager) | | | expenses^{b} | | and | | |
| | | | | | steering^{d} | | |
| Wilhelm | | | | Get | | Change | |
| Schmitz | | | | overview | | staffing | |
| (People | | | | of | | commitment | |
| Manager) | | | | employee | | to | |
| | | | | activities^{e} | | employees^{c} | |
| Tom Tailor | Collaboration^{d} | Self- | Confirm time | | Provide | | |
| (Employee) | | assign | and expenses | | status to | | |
| | | to | (e.g., travel)^{b} | | project | | |
| | | tasks^{b} | | | lead^{d} | | |

^{a}e.g., using the first system 202
^{b}e.g., using the second system 204
^{c}e.g., using either the first system 202 or the second system 204
^{d}e.g., using collaboration component 214
^{e}e.g., using analytics framework 206

In the Execute and monitor step, the involve people execute the initiative or project according to the planning. An integration with the collaboration component 214 can be used for purposes of onboarding an collaboration among team members, or for communicating with external stakeholders. Collaboration groups can be generated and linked to projects or initiatives. If supported, the self-assignment of tasks can be performed in the first system 202. Otherwise, confirmation of time and expenses, and approval thereof, are performed in the second system 206 or in the time and expenses system 222. Stakeholders can track the progress of initiatives and projects proactively in analytics, or receive commented status reports initiated by the responsible persons. For example, the project manager (lead) should automatically be informed about changes to staffing commitments initiated by resource or people managers (e.g., due to other, higher-prioritized projects) so that the project plan can be adjusted.

The initiative and the project can be closed in a “Close” step:

Name

| | | | | |
|---|---|---|---|---|
| Bill McCloud | Close initiative^{a} | | Valuation of | Perform retrospective |
| (Senior) | | | project or | for |
| Manager | | | initiative^{a} | initiative^{a} |
| Lara Bloom | Close project^{b} | | | Perform retrospective |
| (Project | | | | for |
| Manager) | | | | project^{a} |
| Wilhelm | | Adjust Tom's | | |
| Schmitz | | skills record^{a} | | |
| (People | | | | |
| Manager) | | | | |
| Tom Tailor | | Adjust skills | | |
| (Employee) | | and profile | | |
| | | record^{a} | | |

^{a}= e.g., using the first system 202
^{b}= e.g., using the second system 204

When an initiative or project ends, the outcome should be used, and can be reflected in updated employee skills, as well as in goals and performances. When a project closes, the committed resources are freed for possible assignment to other activities. Team members receive system proposals regarding their past activities so that they can update their skills. As another example, the people manager can have the ability to maintain skills of the directly reporting employees. Management can evaluate the achievement of project goals so that they can be used in the performance feedback process of the involved employees. Lessons learned can be documented in the system 200 by the project lead for benefit of future projects.

An initiative or project can be stopped at any time, such as by an early termination. The above closing activities can nevertheless be performed.

Goals and performance can be evaluated in a “Goals and performance” step:

Persona

| | | |
|---|---|---|
| Lara Bloom | | Give feedback about Tom |
| (Project Manager) | | (appraisal)^{a} |
| Wilhelm Schmitz | Define goals for | Consolidate feedback about |
| (People Manager) | employees^{a} | Tom^{a} |

^{a}= e.g., using the first system 202

During performance management activities the assignment of employees to initiatives and projects supports people managers and employees in deriving appropriate goals. In some implementations, initiative/project goals can be directly cascaded to individual employees. Project leads can serve as additional appraisers and can provide feedback on project members. The feedback is collected and consolidated (e.g., by the people manager) to prepare the final assessment of directly reporting employees.

Future workforce requirements can be forecast in a “Workforce planning” step:

| Persona | |
|---|---|
| Wilhelm Schmitz | Predict workforce planning^{a} |
| (People Manager) | |

^{a}= e.g., using the first system 202

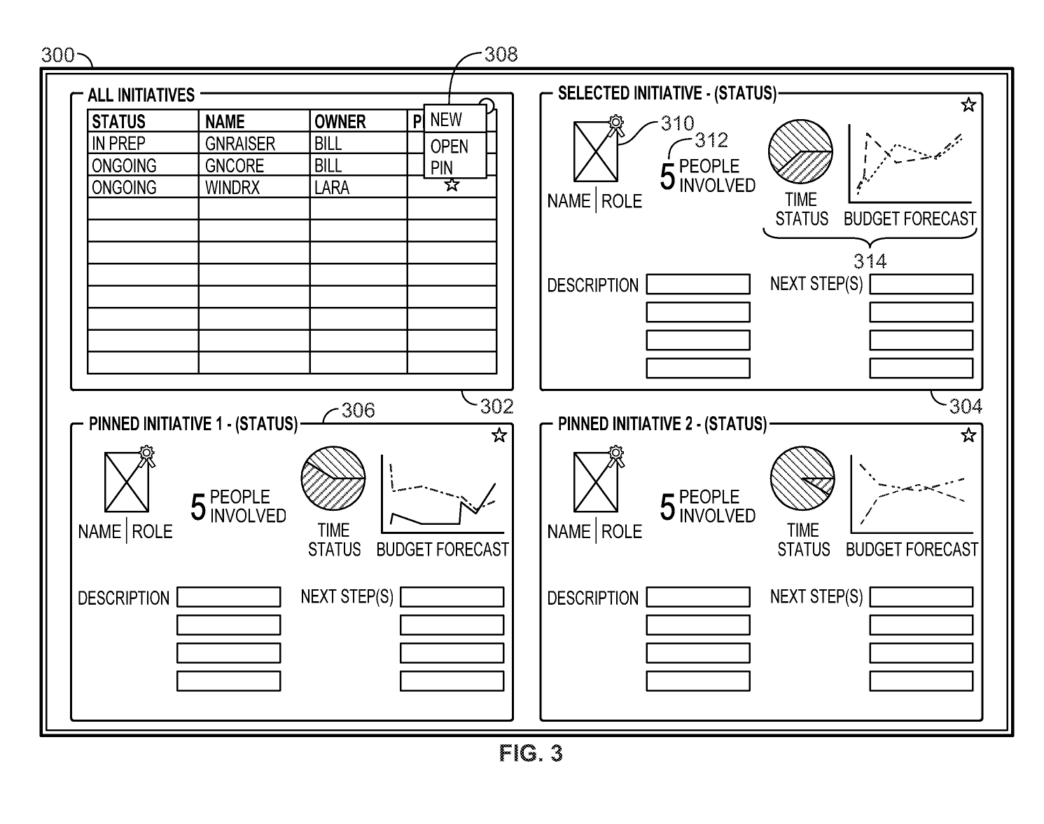

FIG. 3 shows an example of a graphical user interface (GUI) 300 for managing an initiative. The GUI 300 includes an initiatives area 302, a selected-initiative area 304 and one or more pinned-initiative areas 306. The GUI 300 can serve as an overview screen where the user can inspect a list of initiatives. One or more filter criteria can be applied, such as to show “all” or “my” or “active” initiatives, to name a few examples. Using a control 308, new initiatives can be created, existing initiatives can be opened, initiatives can be pinned to (or unpinned from) a favorites menu, or an initiative within the list can be selected.

For each initiative, a field 310 indicates the responsible person, for example in form of a picture combined with a tooltip for contact data or a business card with contact data. A field 312 indicates the involved people, for example reduced to the number of involved people together with a tooltip of a list and further details. As another example, the field 312 can indicate the sum of people assigned to the initiative and to all related projects, or only the (local) assignees of the initiative. A field 314 includes analytical information, for example characteristics and key figures such as the progress or budget of the initiative and related projects. The field 314 can show a graphical diagram or a list view, to name just two examples.

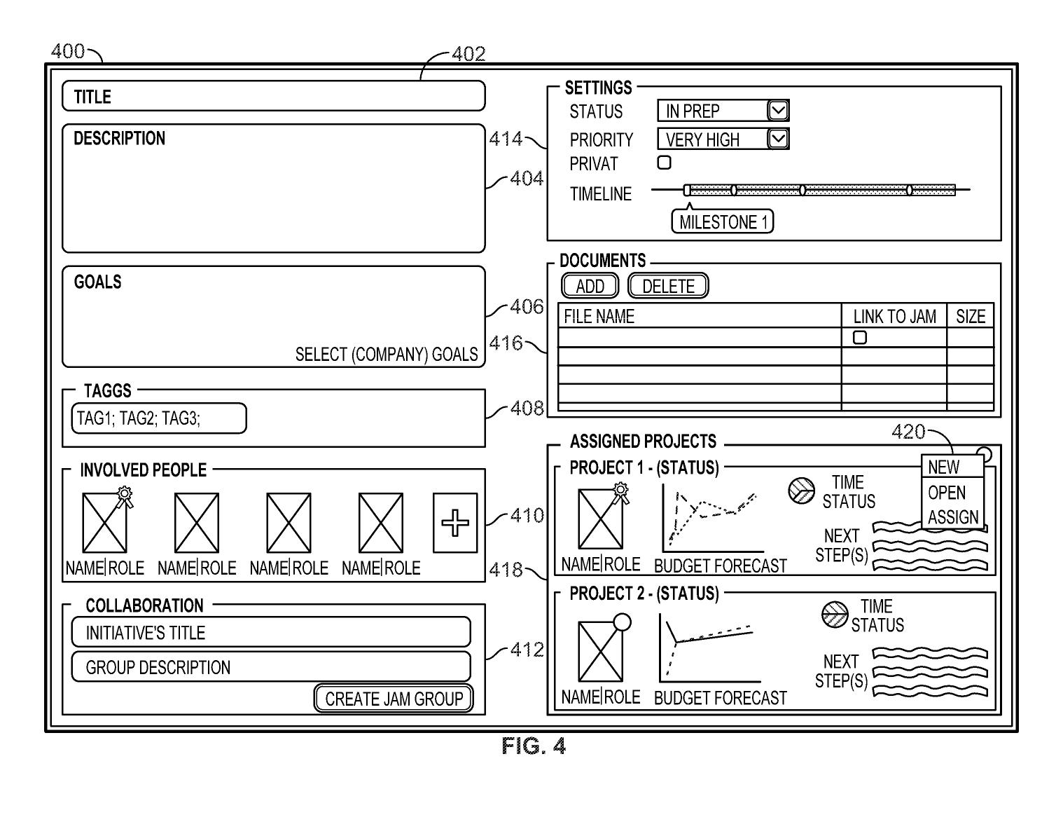

FIG. 4 shows an example of a GUI 400 for defining a new initiative. After an initiative is created, it can be viewed and edited using the GUI 400. The GUI 400 includes a field 402 for entering a title of the initiative, and a field 404 for entering a description. A field 406 is used for specifying (e.g., by selection from a list) one or more goals for the initiative. For example, a textual description can be entered and one or more links to corporate objectives can be provided. A field 408 is used to specify one or more tags for the initiative, such as to label it as relating to “cloud computing.” A field 410 is used for specifying one or more employees as involved in the initiative. For example, the employees can be shown as pictures or in a list view. Some roles (e.g., the initiative owner) can be flagged or otherwise highlighted. A field 412 is used for defining or showing collaboration groups relating to the initiative. A field 414 is used to specify one or more settings for the initiative. For example status (e.g., in preparation, active or closed can be selected from a picklist), priority, private (e.g., for handling authorizations) can be specified. A field 416 is used for adding or viewing one or more documents or links. For example, integration into documents of a collaboration group can be provided. A field 418 is used to specify and view assigned projects and show relevant details thereof, such as project lead, status and analytical information. A control 420 can be used for creating one or more new projects for the initiative, to open an assigned project, and/or to assign an existing project to the initiative.

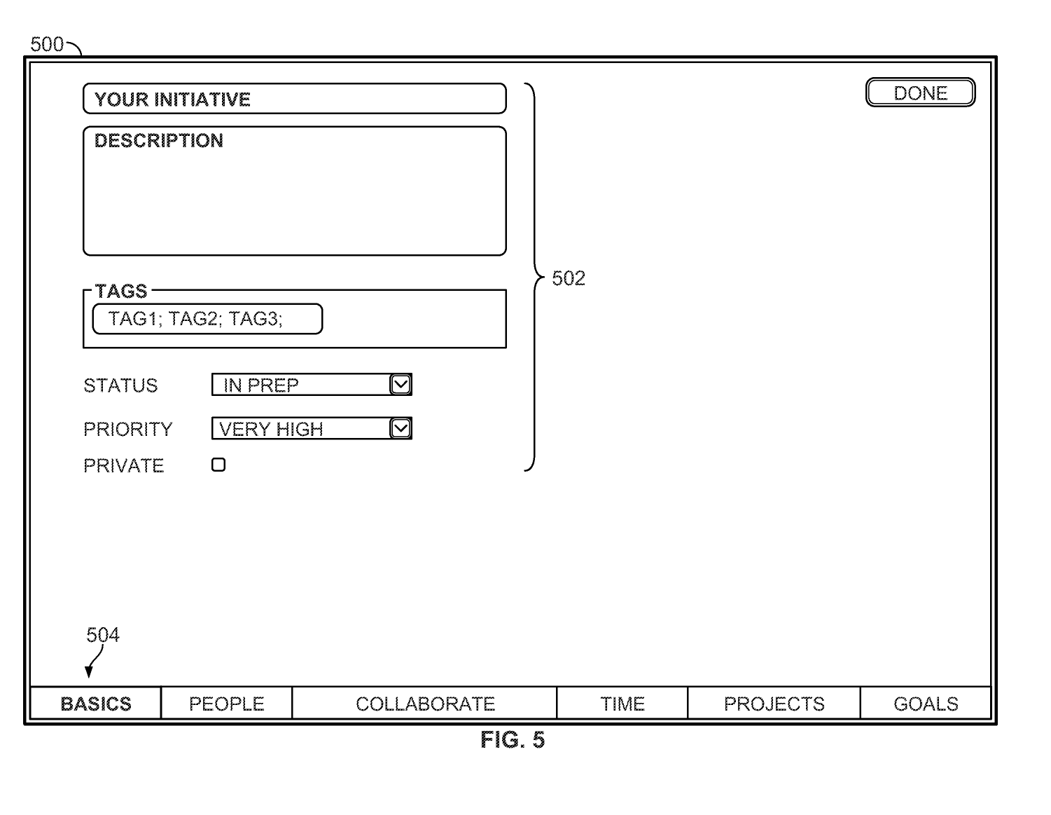

In some implementations, mobile devices (e.g., smartphones, tablets, etc.) can be provided a specific GUI regarding initiatives/projects. FIG. 5 shows another example of a GUI 500 for managing an initiative. The GUI 500 includes a first area 502 for entering or viewing one or more types of information regarding the initiative, including, but not limited to, a name, description tag, status, priority or privacy setting for the initiative. An area 504 indicates that a “basics” view of the initiative is currently shown. In some implementations, the area can be located elsewhere in the GUI 600 such as, but not limited to, vertically along the side of the screen.

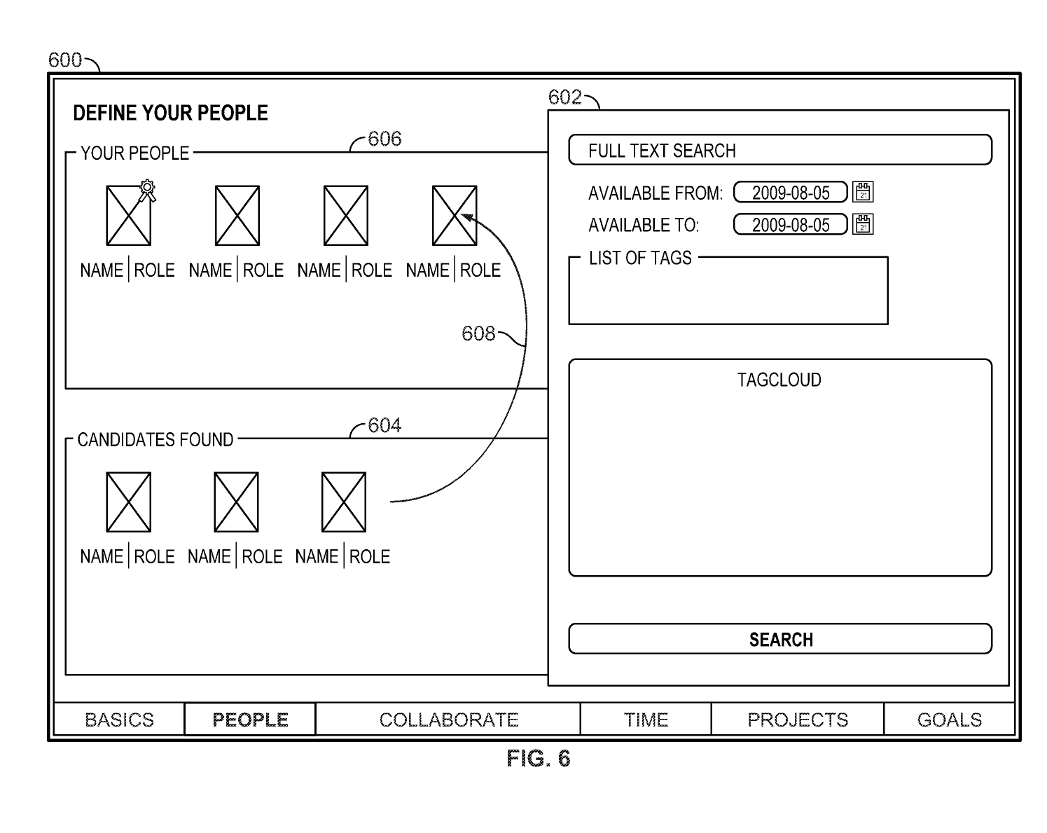

FIG. 6 shows another example of a GUI 600 for defining a new initiative. In some implementations, the GUI 600 is presented upon selection of “people” in the area 504 (FIG. 5). The GUI 600 includes an area 602 for performing an employee search based on one or more criteria (e.g., text search, availability and/or tags), an area 604 for presenting one or more found candidates, and an area 606 for specifying the people assigned to the current initiative. An arrow 608 indicates an action of assigning a found employee to the initiative, such as by a drag and drop operation.

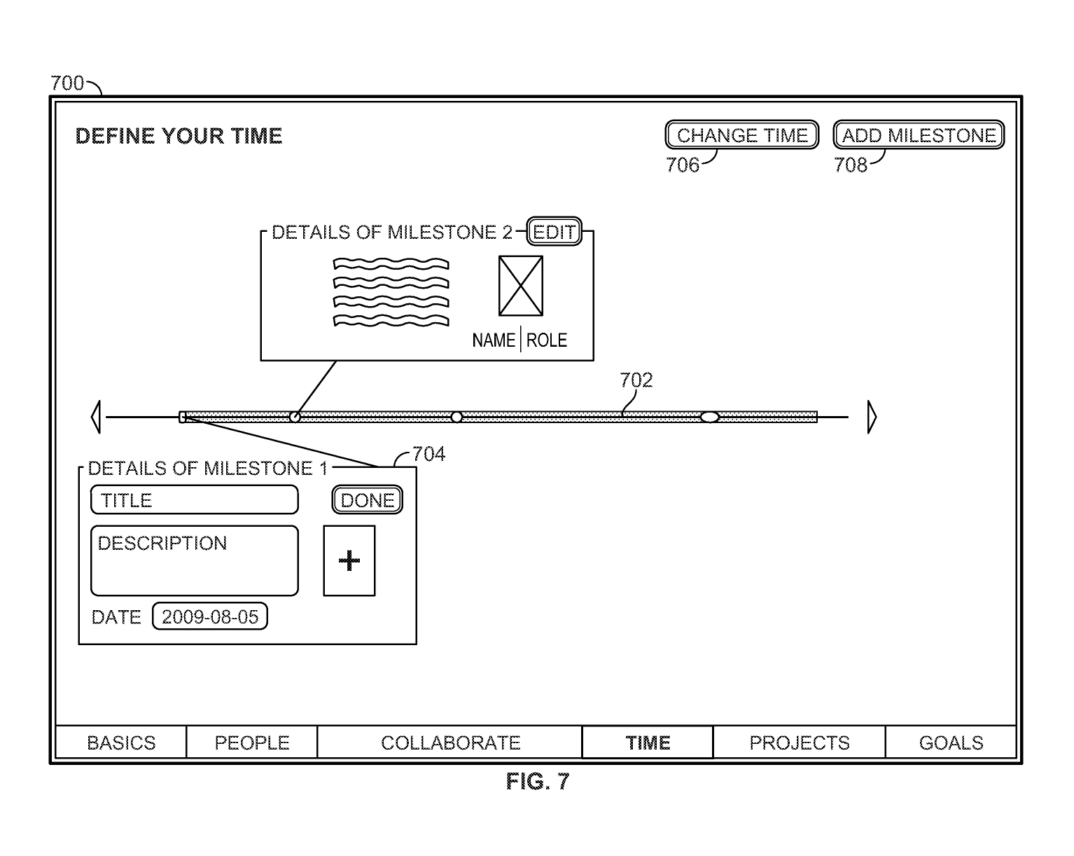

FIG. 7 shows an example of a GUI 700 for defining one or more milestones regarding an initiative. In some implementations, the GUI 700 is presented upon selection of “time” in the area 504 (FIG. 5). A timeline 702 allows one or more events or time periods for an initiative to be indicated. For example, a respective milestone view 704 can be presented for each of one or more defined milestones, and relevant information (e.g., milestone title, description, name/role and date(s)) can be specified. A control 706 can be used to change the time currently viewed in the GUI 700 (e.g., to zoom in or out), and a control 708 can be used to add one or more milestones to the timeline 702.

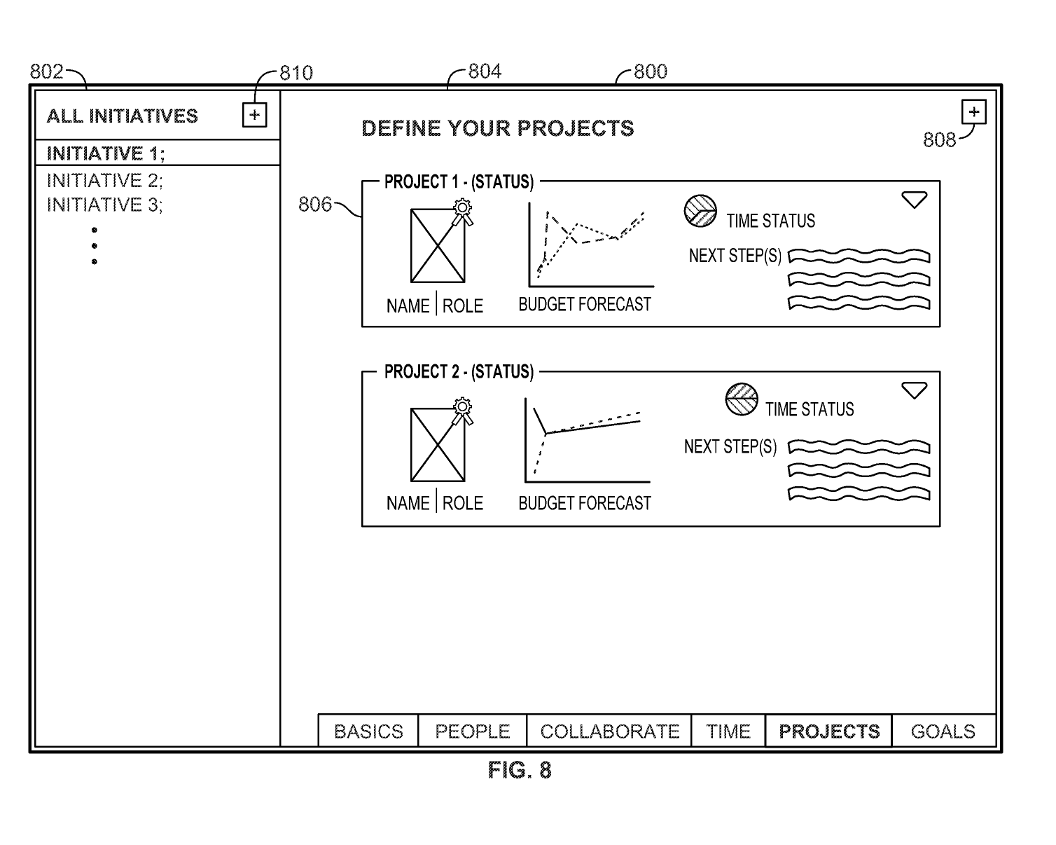

FIG. 8 shows an example of a GUI 800 for managing one or more projects relating to an initiative. In some implementations, the GUI 800 is presented upon selection of “projects” in the area 504 (FIG. 5). The GUI 800 includes an area 802 for selecting one or more initiatives (here, “Initiative 1” is currently selected.) The GUI 800 includes an area 804 that presents a respective project view 806 for each of one or more projects assigned to the selected initiative. For example, the project view 806 can specify the name/role of the project lead and/or analytics information (e.g., a budget forecast or next steps.) A control 808 can be used to add one or more new projects to the current initiative. Similarly, a control 810 can be used to add one or more initiatives.

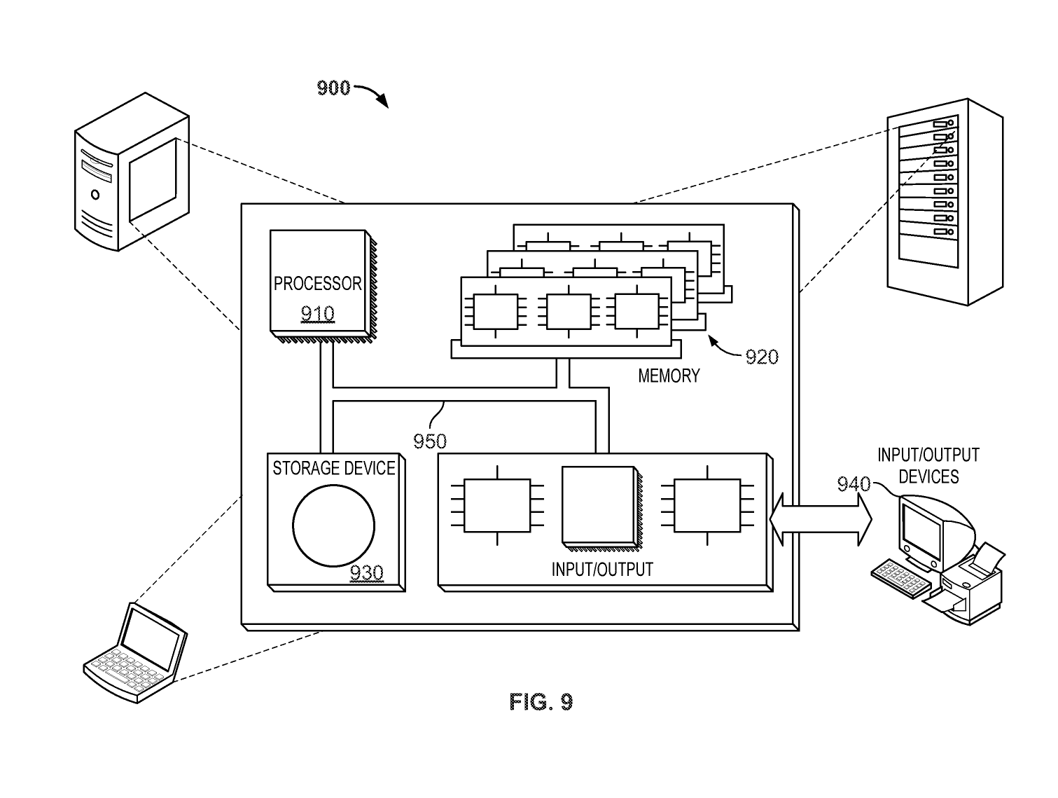

FIG. 9 is a schematic diagram of a generic computer system 900. The system 900 can be used for the operations described in association with any of the computer-implement methods described previously, according to one implementation. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In some implementations, the memory 920 is a computer-readable medium. The memory 920 is a volatile memory unit in some implementations and is a non-volatile memory unit in other implementations.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method comprising:
defining, in a computer system operated by an organization, an initiative object corresponding to an organization decision to explore a topic, and specifying at least a first goal definition and at least a first skills definition for the initiative object;
defining, in the computer system, a project object corresponding to a project undertaken by the organization, the project associated with exploring the topic, and specifying at least a second goal definition and at least a second skills definition for the project object;
searching for one or more employees in an employee skills database of the organization, the searching performed using at least one of the first or second skills definitions, and assigning at least one employee to the initiative object and to the project object, wherein the project object, but not the initiative object, affects employee availability;
upon at least one of the initiative object and the project object being closed, updating a skills record for the employee using at least one of the first and second skills definitions; and
upon at least one of the initiative object and the project object being closed, updating a performance record for the employee using at least one of the first and second goal definitions.

2. The computer-implemented method of claim 1, wherein an initial search of the employee skills database finds no match for at least one of the first or second skills definitions, the method further comprising updating a resource management record to reflect the at least one of the first or second skills definitions.

3. The computer-implemented method of claim 2, wherein the assignment of the at least one employee to the initiative object and to the project object results from one or more of employee hiring, employee training, or consultant retention.

4. The computer-implemented method of claim 1, further comprising associating a third goal definition with the at least one employee using the updated performance record.

5. The computer-implemented method of claim 1, further comprising providing, using the computer system, an interface for collaboration between at least two users involved in at least one of the exploration of the topic or the project.

6. The computer-implemented method of claim 1, wherein the project object is defined using the initiative object.

7. The computer-implemented method of claim 1, wherein the project object already exists, the method further comprising associating the initiative object with the existing project object.

8. A computer program product embodied in a non-transitory computer-readable storage medium and comprising instructions that when executed by a processor perform a method comprising:
defining, in a computer system operated by an organization, an initiative object corresponding to an organization decision to explore a topic, and specifying at least a first goal definition and at least a first skills definition for the initiative object;
defining, in the computer system, a project object corresponding to a project undertaken by the organization, the project associated with exploring the topic, and specifying at least a second goal definition and at least a second skills definition for the project object;
searching for one or more employees in an employee skills database of the organization, the searching performed using at least one of the first or second skills definitions, and assigning at least one employee to the initiative object and to the project object, wherein the project object, but not the initiative object, affects employee availability;
upon at least one of the initiative object and the project object being closed, updating a skills record for the employee using at least one of the first and second skills definitions; and
upon at least one of the initiative object and the project object being closed, updating a performance record for the employee using at least one of the first and second goal definitions.

9. The computer program product of claim 8, wherein an initial search of the employee skills database finds no match for at least one of the first or second skills definitions, the method further comprising updating a resource management record to reflect the at least one of the first or second skills definitions.

10. The computer program product of claim 9, wherein the assignment of the at least one employee to the initiative object and to the project object results from one or more of employee hiring, employee training, or consultant retention.

11. The computer program product of claim 8, the method further comprising associating a third goal definition with the at least one employee using the updated performance record.

12. The computer program product of claim 8, the method further comprising providing, using the computer system, an interface for collaboration between at least two users involved in at least one of the exploration of the topic or the project.

13. The computer program product of claim 8, wherein the project object is defined using the initiative object.

14. The computer program product of claim 8, wherein the project object already exists, the method further comprising associating the initiative object with the existing project object.

15. A system comprising:
one or more processors; and
a computer program product embodied in a non-transitory computer-readable storage medium and comprising instructions that when executed perform a method comprising:
defining, in a computer system operated by an organization, an initiative object corresponding to an organization decision to explore a topic, and specifying at least a first goal definition and at least a first skills definition for the initiative object;
defining, in the computer system, a project object corresponding to a project undertaken by the organization, the project associated with exploring the topic, and specifying at least a second goal definition and at least a second skills definition for the project object;
searching for one or more employees in an employee skills database of the organization, the searching performed using at least one of the first or second skills definitions, and assigning at least one employee to the initiative object and to the project object, wherein the project object, but not the initiative object, affects employee availability;
upon at least one of the initiative object and the project object being closed, updating a skills record for the employee using at least one of the first and second skills definitions; and
upon at least one of the initiative object and the project object being closed, updating a performance record for the employee using at least one of the first and second goal definitions.

16. The system of claim 15, wherein an initial search of the employee skills database finds no match for at least one of the first or second skills definitions, the method further comprising updating a resource management record to reflect the at least one of the first or second skills definitions.

17. The system of claim 16, wherein the assignment of the at least one employee to the initiative object and to the project object results from one or more of employee hiring, employee training, or consultant retention.

18. The system of claim 15, the method further comprising associating a third goal definition with the at least one employee using the updated performance record.

19. The system of claim 15, wherein the project object is defined using the initiative object.

20. The system of claim 15, wherein the project object already exists, the method further comprising associating the initiative object with the existing project object.
